(19) United States
(12) Patent Application Publication
(10) Pub. No.: US 2004/0078809 A1
(43) Pub. Date: Apr. 22, 2004

(54) Targeted advertising system

(76) Inventor: Jonathan Drazin, South Oxfordshire (GB)

Correspondence Address: Philip R Poh, Fish & Neave, 1251 Avenue of the Americas, New York, NY, 10020-1104, US

(21) Appl. No.: 10/276,837

(22) PCT Filed: May 21, 2001
(86) PCT No.: PCT/GB01/02225

(30) Foreign Application Priority Data
May 19, 2000 (GB) 00122119

(51) Int. Cl. H04N 7/025; G06F 13/00; H04N 5/445; G06F 3/00; H04N 7/10

(52) U.S. Cl. 725/34; 725/35; 725/46

(57) ABSTRACT

A system for targeting adverts at viewers comprising a set box (STB) (22) having a processor that is operable to read a plurality of viewer characteristics relating to an image that is currently being viewed. These viewer characteristics typically provided by the television broadcaster or another remote data center (24). The viewer characteristics are used by the STB (22) to construct a multi-dimensional viewer profile. Each time the viewer views a television program, the information in the viewer profile is updated. In order to target adverts at specific viewers, the viewer profile is compared with a multi-dimensional target viewer profile associated with an advert. In the event that there is a sufficient match, the advert is displayed on the television screen.

This invention relates to a targeted advertising system, in particular a targeted advertising system for a television or a television system.

It has been long recognised that specifically targeted advertising is more effective than using an unfocused approach. With television, it is, however, difficult to target adverts other than by theme. For example, during a football match, adverts may be shown at the intervals relating to the sale of football videos or football strips. Likewise, during pop music shows, adverts at the intervals may be for specific albums by specific artists. The problem with this is that the adverts are displayed to everyone watching the program. There is no way of targeting different adverts to different individuals based on that individual's preferences. A further problem is that buying prime time television advertising slots can be expensive.

Another known system provides the capability for advertisers to selectively display advert panels as logical and quantitative functions of programs viewed by theme (such as sports, news, comedy, etc.), channel and rating. For example a TV channel may selectively display a panel in cases “where football is viewed more than 2 hours per week”. Alternatively, a TV channel may selectively display a panel in cases where viewers are “not viewing its channel” AND “where football is viewed more than 2 hours per week”. The resulting capabilities give advertisers a way to target viewers based upon their viewing history. However, a number of deficiencies exist that limit the wide-scale applicability of this system. As before, the main disadvantage is that the adverts are targeted mainly by theme. This is a disadvantage because relatively few products map directly to a TV theme. Even in cases where a close product theme relation does exist, e.g. golf clubs and “golf”, it is questionable whether the full extent of a potential customer base has been adequately addressed. In this example, many more may play the sport than watch on TV. Likewise, those who watch golf on television may never leave their armchair to play it.

Various relatively sophisticated systems are known for targeting advertising. However, most of these involve a degree of feedback from the viewer to a central controller, which monitors the viewer's viewing preferences and determines which adverts are to be transmitted or downloaded to them. Such systems, however, suffer from the disadvantage that viewers' behaviour is being monitored, in their own home, by an external party. Whilst this monitoring is done with the aim of providing viewers with advantageous information, many people are uneasy about allowing that level of surveillance in their home. A further problem is that some systems of this nature have fallen foul of data privacy laws in various countries.

An object of the present invention is to provide a system that enables adverts and services to be targeted more accurately, without compromising a viewer's right to privacy.

Various aspects of the invention are defined in the independent claims. Some preferred features are defined in the dependent claims.

Various aspects of the present invention will now be described by way of example and with reference to the accompanying drawings, of which:

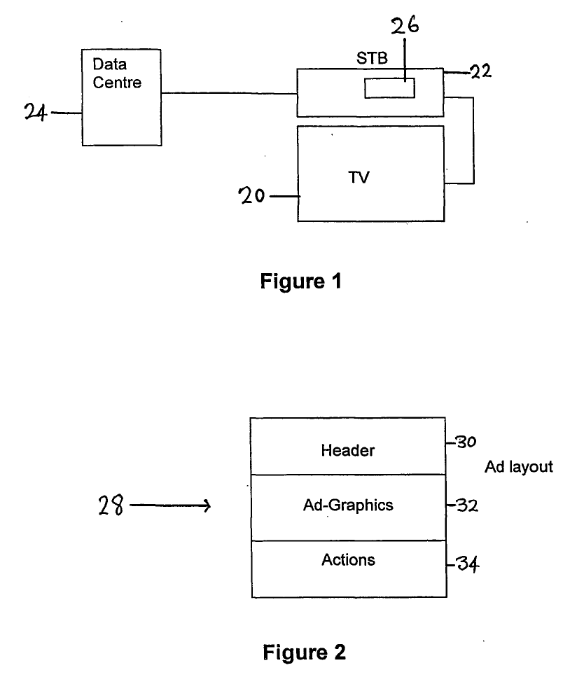

FIG. 1 is a diagrammatic representation of a television system;

FIG. 2 shows the structure for an advert that is stored in the memory of the system of FIG. 1;

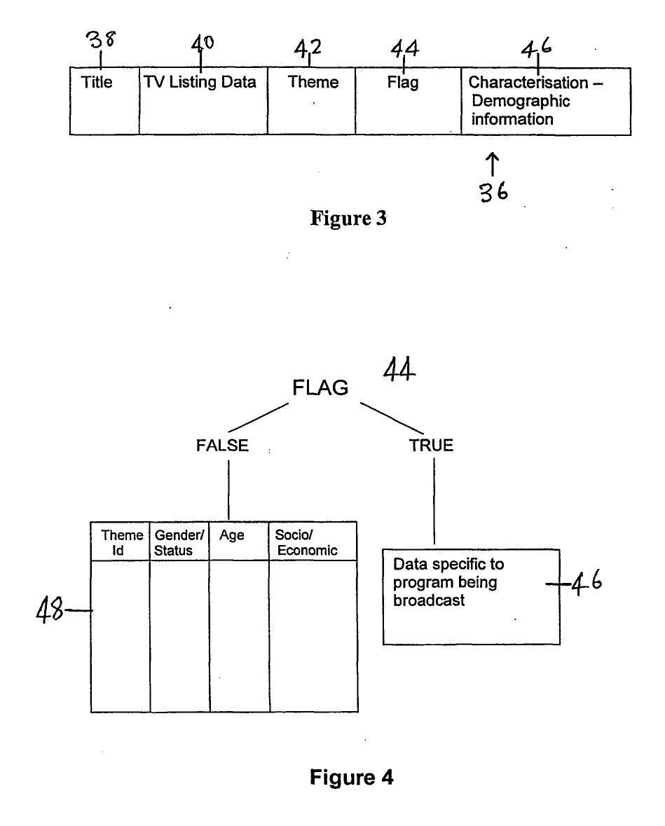

FIG. 3 shows a data stream that is associated with a particular television program;

FIG. 4 is a diagrammatic representation of the flag of FIG. 3;

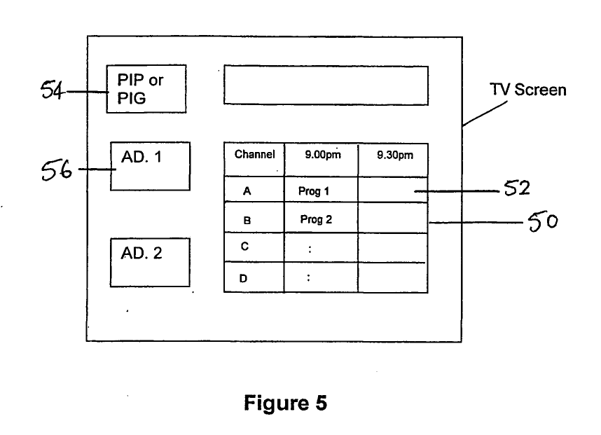

FIG. 5 shows a screen layout for an EPG;

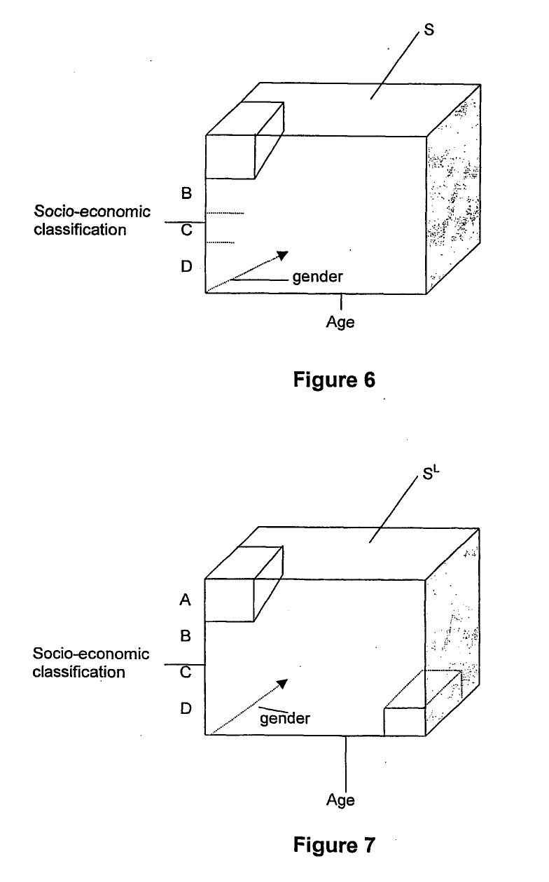

FIG. 6 is a graphical representation of demographic information associated with a particular viewer;

FIG. 7 is a graphical representation of demographic information associated with an advert;

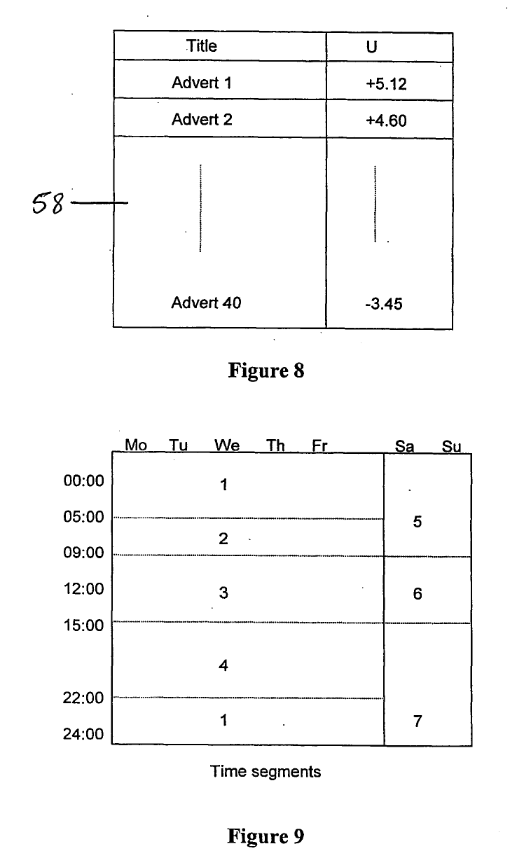

FIG. 8 is a list of adverts and their instantaneous urgencies, U;

FIG. 9 is a table showing an example of time segmentation; and

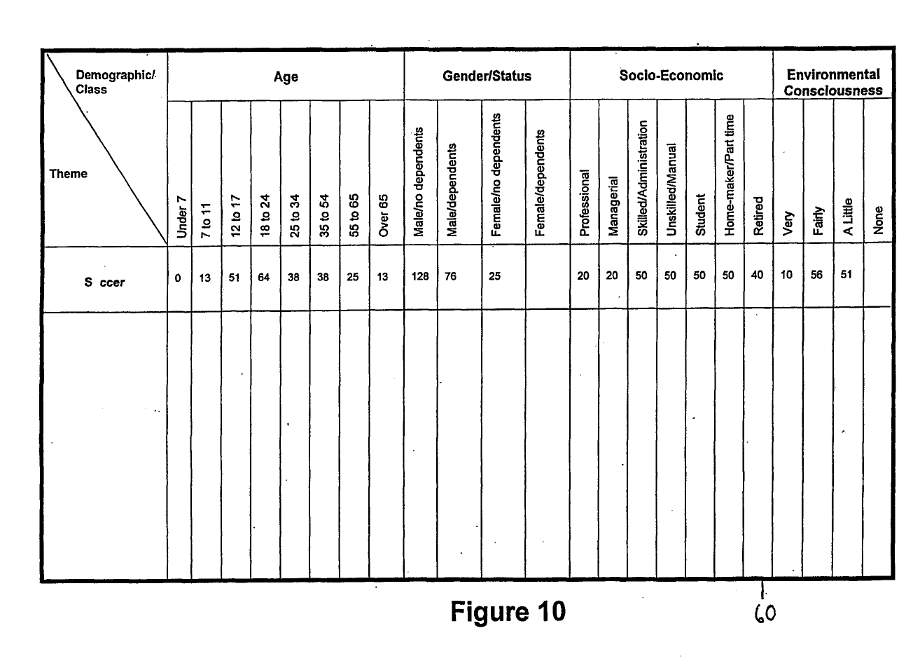

FIG. 10 is a table of probabilities;

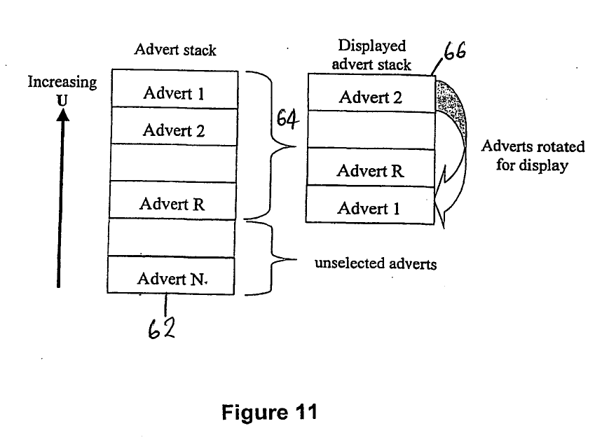

FIG. 11 is a graphical representation of the selection for display of an advert from multiple possible stored adverts;

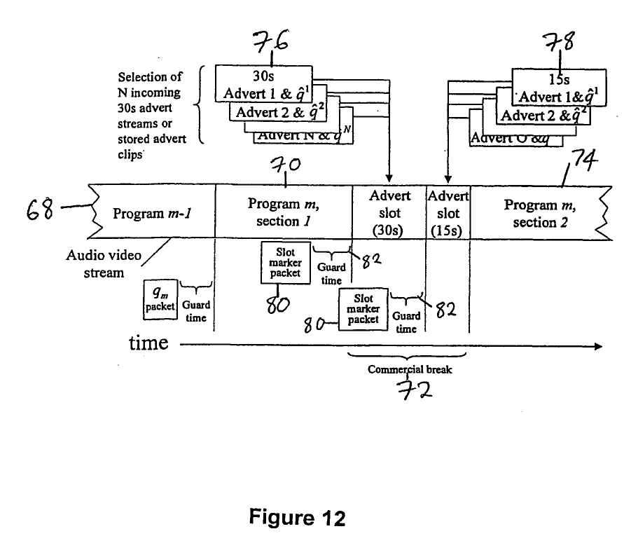

FIG. 12 is diagrammatic representation of the placement of audio video advert clips within segments of a broadcast or playback content stream;

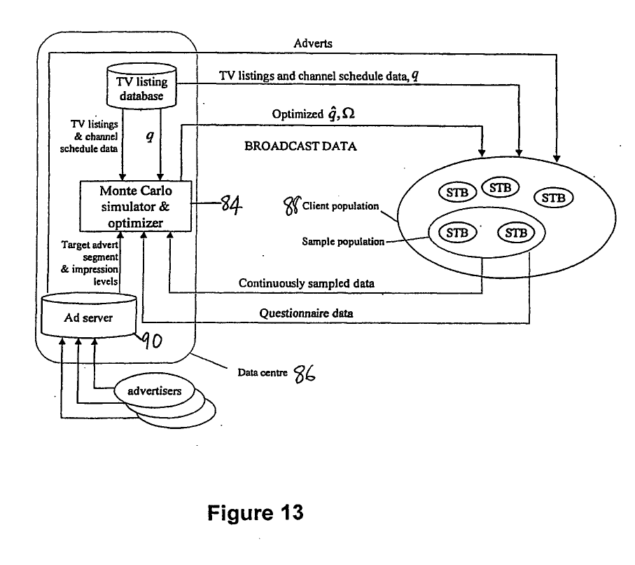

FIG. 13 is a diagrammatic representation of the advertising system.

FIG. 1 shows a television 20 connected to a set-top-box (STB) 22 that is operable to communicate with a remote data centre or broadcaster 24. Included in the STB 22 is a microprocessor 26 and a memory (not shown) that contains a software application for receiving and displaying targeted adverts to a viewer. Of course, the application could be stored and run in any suitable device such as the television itself, a PC, a video recorder, such as a VCR, DVD or PVR, a mobile telephone, a portable electronic book (eBook), or media player, or a PDA.

Stored in the memory of the STB 22 for use by the software application is a plurality of adverts that can be presented to the viewer, together with demographic information associated with each advert. As shown in FIG. 2, the stored advert 28 typically has three parts—a header 30 that includes the target viewer demographic information, a mid-section 32 that contains the advert's audio visual information, e.g. graphics text, video, animations, and a footer 34 that includes an application for effecting certain actions and responses to viewer interactions.

The actions defined in the advert footer 34 are a sequence of tasks (which may be defined as executable software) that may be performed by the STB 22 in response to viewer prompts. For example, an action in response to a viewer seeing a car advertisement may be for the STB 22 to dial a telephone number, via an integral modem, or send an e-mail to the advertiser in response to a request from the viewer.

In addition to available adverts, included in the STB 22 is software for providing an electronic program guide (EPQ) that has listings of television programs that are available, generally over a period of, say, two weeks.

Television signals are transmitted or downloaded to the television from the broadcaster 24, in a conventional manner. Alternatively, they may be played off a storage device within the STB 22 or some other video recorder or remotely across a network from a video-on-demand server. Demographic and/or psychographic and/or lifestyle information relating to the viewer characteristics of television programs are transmitted or downloaded to the STB 22. This can be done with the actual program as it is being broadcast or with the television schedule information that is used to construct the EPG or in a separate dedicated transmission.

FIG. 3 shows an example of a data stream 36 that would be sent, when the viewer characteristics, in particular demographic and psychographic information are downloaded with the EPG or TV listing information. Included in the data stream is the following:

the title of the television program 38;

TV listing information, e.g. time of broadcast and duration, for use in constructing an electronic program guide 40;

television program theme, e.g. sports, comedy, news etc 42;

a true or false flag that indicates whether a default set of demographic information is to be used according to the program's theme or whether a program specific set follows in the data stream 44;

specific demographic information for the program (provided the flag is “true”) 46;

When a data stream of this form is used, a default set of demographic information, classified according to television program theme, is stored in a default table within the memory of the STB 22. When the flag 44 is set to “False”, the demographic information relating to the program theme is read from the default table 48 of values, as shown in FIG. 4. Using this particular arrangement is advantageous as it reduces the amount of information that has to be downloaded to the viewer equipment. There are, however, some circumstances in which the use of default information is not appropriate. To take this into account, the flag 44 can be set to “True” to indicate that the default settings are not to be used. In this case, specific demographic information for the program is included in the “characterisation” portion of the data stream.

The software application in the STB 22 is operable to read the demographic information associated with a currently viewed program and demographic information associated with a plurality of adverts. Once this is done, the television program demographic information is compared with the stored advert demographic information. In the event that there is a sufficient match between the program demographic information and the advert demographic information, the advert is selected for display.

The advert can be displayed at appropriate times during the program or alternatively via the viewer's EPG. In this way, advertisers are able to reach individual viewers who are likely to fit within a certain demographic profile. For example, if the “Naked Chef” is classified as being viewed by thirty-something, female, professionals and a pensions advert is to be targeted at that group, then when the Naked Chef is being viewed on screen, the television system is able to selectively display the pensions advert at a pre-determined time, which can then be viewed by its target audience. This is advantageous. A further advantage is that the system is wholly located in the viewer terminal and so adverts can be targeted without compromising the viewer's privacy.

As regards the advert, this can be displayed in many different ways. For example, as shown in FIG. 5, the advert could be displayed as an ad panel that is part of the EPG 50, together with the program listings 52 and a reduced size view of the currently viewed television program, which is shown as a picture-in-guide (PIG) box 54. In this case, the advert would be displayed when the viewer enters the EPG 50. Alternatively, the advert may comprise a pop-up icon that appears on the viewer's television screen, which when selected provides more information. The advert may display static or scrolling information. In addition, it may be animated or moving and may include graphics and/or text. As a further example, the advert may be full screen sound and video, which is displayed in synchronisation with data time stamps buried within or between the programs currently being viewed. This will be described in more detail later. In any case, the adverts may be downloaded to the television system (such as into a PVR) prior to viewing, or they may be broadcast simultaneously as concurrent analogue TV channels or multiplexed as digital TV data streams at the time of viewing.

The advert may contain content embedded within it, e.g. within the memory space allocated to the actions 34 in FIG. 2. Such content may be a conventional audio-visual television programme, e.g. a movie, music video etc, multimedia content, e.g. HTML, SGML or Java document etc. The content could also be a software application e.g. a machine executable application such as a TV game, e-commerce application etc. or some combination thereof which, upon selection by the viewer of the advert, causes the advert's embedded content to be played or executed on the STB 22 and displayed to the viewer via a television display device. Alternatively, an advert may contain a link or URL to content that is stored separately from the advert within the STB 22 or a remote media server across a data network, e.g. DSL or cable network, LAN, WAN etc. Alternatively, the advert may include a link to content that is available to be downloaded to the STB 22 from a repetitively broadcast carousel, e.g. cable or satellite MPEG DSM-CC data carousel etc. When a graphical play or run option is selected by the viewer, the advert's actions cause the advert's content to be downloaded from a remote server or broadcast carousel and played or executed on either the remote server or STB 22 as applicable and to be displayed to the viewer via a television display device.

The advert content, whether embedded within or linked to an advert's actions, may be encrypted. Optionally a part of the advert's actions may conduct a process of giving a viewer access to viewing or playing of the stored or linked advert content conditional upon a process of electronic payment or financial accounting that is executed within either the STB 22 or a remote server, or some combination thereof.

Many different types of demographic and/or psychographic information may be used to describe a program's viewing audience, for example age, gender/status and socio-economic classification and environmental consciousness. A preferred segmentation of these categories is as follows:

1. Age

(i) Under 7,

(ii) 7 to 11,

(iii) 12 to 17,

(iv) 18 to 24,

(v) 25 to 34,

(vi) 35 to 44,

(vii) 45 to 54,

(viii) 55 to 64,

(ix) 65+;

2. Gender/Status

(i) male, no dependants,

(ii) male, dependants,

(iii) female, no dependants,

(iv) female, dependants;

3. Socio-economic

(i) professional (doctor, lawyer, director)

(ii) managerial

(iii) skilled/administrative

(iv) unskilled/manual

(v) student

(vi) homemaker/part-time

(vii) retired

4. Environmental consciousness (psychographic)

(i) very conscious;

(ii) fairly;

(iii) a little;

(iv) not at all.

Using particular groups of demographic categories and segmentations, television programs may be associated with, for example, the following specific demographic characterisations:

Professional males, aged 35 to 54;

Female students, aged 18 to 24;

Children aged 7 to 11;

“Mothers” (eg female with dependants, aged 18 to 54)

It will be appreciated that the above representations are given only as an example and the demographic/psychographic segmentations may be changed as and when desired. This could be done by, for example, downloading new segmentation information to the STB 22 non-volatile memory.

Using the segmentation of television programs and adverts allows adverts to be specifically directed to specific types of people. This is advantageous.

In order to target adverts more specifically, the television system of FIG. 1 is operable to monitor the viewing habits of the television viewer. In this way, viewing profiles of the television system can be built up over time for each time segment. In order to do this the software application in the STB 22 is operable to adjust continuously the stored viewer characteristics for the current time segment to reflect partially the viewer characteristics associated with the currently viewed program or its theme.

In addition to up-dating demographic viewer profile information associated with each time segment, the application may log STB 22 viewing durations and frequencies of programs according to theme, channel and time segment. This allows the application to display selectively adverts as a function both targeted viewing profile and STB 22 usage, where such information is contained in the Header 30 section of FIG. 2. The application might, for example, target viewers as follows:

“Professional males, aged 35 to 54” AND/OR “where STB is tuned to golf program more than once per week”;

“Female students, aged 18 to 24” AND/OR “where STB can receive Channel 4”;

“Children aged 7 to 11” AND “where STB is tuned to Nickleodeon channel for more than one hour per week”;

“Mothers” AND “STB is tuned to fashion program more than once per month”.

In order to characterise the viewer profile, various methods can be employed. However, in the preferred such method, the characteristics of a viewer of a program are expressed in terms of an N-dimensional probability distribution P, where each dimension corresponds to a demographic viewer classification scheme, or class.

Each class, c, e.g. age, gender or socio-economic, is complete mathematically and contains a number, n_{c}, of mutually exclusive attributes, so that P has

$${\prod }_{c = 1}^{N} {n}_{c}$$

cells in total, where each cell represents the probability that a viewer of a program has a particular attribute permutation. The probability q that a viewer has an individual class attribute is q_{ca}, where a denotes an attribute within a class c. The attribute probabilities within each class sum to unity.

Further it is assumed ideally that the probabilities of occurrence of attributes between classes are not statistically correlated, so that the probability, p_{J} that a viewer may correspond to a particular permutation of attributes (e.g. J{“female”; “30-35 years”; “group C1”}) is the product of their probabilities

$${\prod }_{c = 1}^{N} {q}_{{cJ}_{c}}$$

where the sum of all the cells in P is unity.

Maintained in non-volatile memory is a weighted average of the probability distributions from recently viewed programs, S, which is updated over time as viewing of each new program, m, is recorded.

When three demographic parameters are used, such as age, gender/status and socioeconomic class, the probability distribution for each time segment can be represented as a distribution in three-dimensional space S, as shown in FIG. 6. Every time a viewer watches a program, the demographic information associated with it is used to up-date the distribution of FIG. 6 for its corresponding time segment. In this way a demographic profile of the viewer is built up.

To improve the statistical accuracy of the model, the probability is weighted using an “effective program weighting factor”, v, to take into account the fact that the whole of a program may not have been viewed. This weighting factor may take several forms, however, as an example, it could be taken to be a fraction of the length of the program viewed or the absolute amount of time the segment was viewed.

Normally, S is maintained as a decay weighted average over W past viewed programs according to:

$${S}_{m} = \frac{( W - {v}_{m} ) {S}_{m - 1} + {v}_{m} {P}_{m}}{W} , \text{for} {\sum }_{e = 1}^{m - 1} {v}_{e} \geq W \qquad ( 1 )$$

where m is mth program to be viewed on the STB. When the cumulative number of effectively viewed segments is below W:

$${S}_{m} = \frac{{S}_{m - 1} {\sum }_{e = 1}^{m - 1} {v}_{e} + {v}_{m} {P}_{m}}{{\sum }_{e = 1}^{m} {v}_{e}} , \text{for} {\sum }_{e = 1}^{m - 1} {v}_{e} < W \qquad ( 2 )$$

S is always normalised, so that its magnitude is independent of the number of events viewed—cycling over roughly every W events. W is a constant somewhere in the range 10 to 500. The greater the size of W the slower the STB's adjustments S to reflect changes in viewing behaviour.

As mentioned previously, each advert contains a header with target viewer characteristics. In the preferred method, this information is age, gender/status and socioeconomic class and is contained in a three dimensional space Ŝ^{L} that defines the profile of its target audience, see FIG. 7. Ŝ^{L} is typically sparse and so, to reduce the number of Ŝ^{L} cell coefficients that must be broadcast, its cells may be approximated to the products of class attribute probabilities \hat{q}_{ca} by broadcasting only \hat{q}_{ca}.

In order to target specific adverts towards a particular viewer, the demographic parameter spaces Ŝ^{L} and S, which define a specific advert L and viewer profiles respectively, are correlated. This is done continuously during viewing time for every advert that is stored in or received by the set-top box. The degree of overlap for each advert is compared and the adverts that match the viewer's profile most closely are displayed.

In order to determine a match between advert and viewer demographic profiles, an “urgency variable”, U^{L} is calculated in order to rank the urgency for each advert to be displayed based upon the overlap between Ŝ^{L} and S. To do this for each advert, L, a demographic profile space, \hat{P}^{L}, for its target audience is calculated. Each cell \hat{P}_{J}^{L} in \hat{P}^{L} is calculated as

$${\prod }_{c = 1}^{N} {\hat{q}}_{c {j}_{c}}^{L} ,$$

where

$${\hat{q}}_{c {j}_{c}}^{L}$$

are target sub-segment weighting coefficients in the range 0.0 to +1.0 for each attribute in, each class that are contained in the Header section of an advert L as described in FIG. 2.

For each advert an “urgency” variable, U^{L} is calculated as a match or probability overlap between Ŝ^{L} and S:

(3)

$${U}^{L} = {\sum }_{j = 1}^{η} {\hat{p}}_{J}^{L} {s}_{J} \qquad ( 3 )$$

where ŝ_{J}^{L} and sⱼ are the J'th cells in Ŝ^{L} and S respectively.

Further, it is desirable to match certain adverts to the current program's viewing characteristics: Pₘ. For example, it may be desired that an advert for training shoes is always displayed when its target market's viewer characteristics overlap with those of the program currently being viewed irrespective of previous viewing history. To achieve this, each advert carries in its Header a current segment weighting parameter, Ω^{L} whose valid range is from 0 to 1, to determine the extent to which \hat{P}^{L} is matched with Pₘ as opposed to S. So that U^{L} is actually calculated as:

$${U}^{L} = {\sum }_{J = 1}^{η} {\hat{p}}_{J}^{L} [ ( 1 - {Ω}_{L} ) {s}_{J} + {Ω}_{L} {p}_{J , m} ] \qquad \text{(3a)}$$

Adverts, for example ad panels, with the highest U values are selectively displayed.

FIG. 8 shows an example of a table 58 that lists the values of U^{L}, together with the titles of the relevant adverts. Alternative formulae in place of (3) and (3a), such as a correlation coefficient formula, may also be used.

Adverts with the highest U^{L} values are selectively displayed, either alone, during a currently viewed television program or as part of an electronic program guide. Hence, the system allows adverts to be specifically targeted based on a continuously up-dated viewing profile. This is done without having to monitor the viewer's behaviour at a remote location.

On its own, the match between target and actual viewing profiles may fail to discriminate between individual viewers in a home. Different viewers in the same home frequently have markedly different habits according to personal favourite viewing times of day. This can be used to advantage by modifying S to become S′, where S′ includes an implicit time segmentation, so that each cell within S maps to an array of n time segments within S′. (1) and (2) become:

$$\begin{matrix}{S}_{m , t}^{′} = \frac{( W - {v}_{m} ) {S}_{m - 1 , t}^{′} + {v}_{m} {P}_{m}}{W} , \text{for} {\sum }_{e = 1}^{m - 1} {v}_{e} \geq W & \text{(1a)} \\ {S}_{m , t}^{′} = \frac{{S}_{m - 1 , t}^{′} ( {\sum }_{e = 1}^{m - 1} {v}_{e} ) + {v}_{m} {P}_{m}}{{\sum }_{e = 1}^{m} {v}_{e}} , \text{for} {\sum }_{e = 1}^{m - 1} {v}_{e} < W & \text{(2a)}\end{matrix}$$

where t is time segment during which program m is viewed.

S′ is now a time dependent probability space whose individual cells represent the probability that a viewer with a specific class attribute permutation views during a particular time segment. It is envisaged that weekdays and weekends will be segmented differently. The segmentation could, for example, be as follows (see FIG. 9):

(i) weekday late night-early morning, eg 22:00 to 05:00

(ii) weekday early morning, eg 05:00 to 09:00

(iii) weekday morning-afternoon, eg 09:00 to 15:00

(iv) weekday evening, eg 15:00 to 22:00

(v) weekend morning, eg 00:00 to 09:00

(vi) weekend midday, eg 09:00 to 15:00,

(vii) weekend evening, eg 15:00 to 24:00.

In order to obtain a closer match between advert and viewer that reflects the time of viewing, the urgency variable U^{L} for an advert is calculated only with S′ for the currently viewed time segment, T:

(3b)

$${U}^{L} = {\sum }_{J = 1}^{η} {\hat{p}}_{J}^{L} [ ( 1 - {Ω}_{L} ) {s}_{J T}^{′} + {Ω}_{L} {p}_{J , m + 1} ] \qquad \text{(3b)}$$

where ŝ_{J}^{L} and s_{JT} are the J'th cells in Ŝ^{L} and S′_{i=T} respectively.

In this way, the advert can be targeted to the specific viewer characteristics associated with a current time of day or week.

As an example of how the time segmentation would work in practise, consider a situation where a television system can be viewed by a family that includes a mother who works at home, a father who works all day and returns home at about 7pm and a child who is at school and goes to bed at about 7.30pm. Each member of the family has a different viewing profile. For example, the mother may watch television in the afternoon while the child is at school and the father may watch television in the early morning before going to work. Each of the mother and father then has viewing habits that lie in different time segments, the mother watching within time segment (iii) and the father watching within time segment (ii). By dividing the day into time segments, the urgency profile U^{L} for both the mother and father in the relevant segment can be calculated and so the adverts can be specifically targeted at them, despite the fact that they are both viewing programs using the same television.

As regards implementation of the specific embodiment, only the algorithm that is used to match the target and the actual demographic profiles would be written as firmware and stored in the viewer's equipment. Values of parameters N, n_{c}, W and choice of weighting algorithm v, would be broadcast downloaded to the STB. Consequently, no decision on the nature of the segmentation scheme, or on the nature of the classes or their attributes, needs to be taken in advance.

Moreover, the scheme can be tailored individually to territories and be optimised over time.

The scheme requires a proportion of events to be characterised with q_{ca} values. The majority of these would not require broadcasts of individual characterisation data, but could effectively be described using a preloaded look-up table whose IDs link to the event theme ID, as described more generally in relation to FIG. 4. When the demographic information includes age, gender and socio-economic status as described above, q_{ca} values are needed for every class and every attribute within each class. A suitable look-up table 60 for this range of information is provided in FIG. 10. Non-volatile storage is needed for the look-up table shown in FIG. 10, which is typically broadcast at the same time as the segmentation scheme or upon a change in thematic classification.

From FIG. 10 it can be seem that the probabilities of the different classifications of viewer watching, say, soccer, are:

Class ID:Soccer

| | |
|---|---|
| Age: | 0, 13, 51, 64, 38, 38, 25 |
| Gender: | 128, 76, 25 |
| Socio-economic: | 20, 20, 50, 50, 50, 50, 40 |
| Environment: | 10, 56, 51 |

The numbers indicate the probability that a particular type of person is viewing a program and are expressed in single byte format where 255 represents 100% probability. Since all attribute probabilities within a class sum to 100% the last probability of each class can be inferred and is not necessarily downloaded to the STB. Referring to the example shown in FIG. 10 and using the attributes described earlier, it can be seen that the most likely viewer for a soccer match is characterised as being aged 25-54 and male, without dependants.

In order to strengthen the quality of S′, certain individual television programs may warrant specific characterisation for various reasons, e.g. (a) popular events on major channels; (b) demographically/psychographically focussed audiences (e.g. a classical opera or documentary on, say, “breast cancer” or “DIY”); (c) no or inaccurate thematic characterisation.

The example segmentation scheme described above contains 4 classes (i.e. age/gender/socio-economic status/ environmental consciousness) and would require 896 (8×4×7×4) double byte integer cells of non-volatile storage for S′ in each of the 7 segments: 6,272 cells altogether. The whole matrix P is not required, since its individual cells can be generated on the fly from q.

Individual characterisations may be broadcast for popular viewed non-thematic events on only the most popular channels. Also such data needs only to be broadcast, received and stored for the present/following day. Importantly, the scheme does not require the broadcast of complex matching criteria or executable instructions within advert headers. This is advantageous in so far that less effort is required by an advertiser to specify and write advert headers during their creation.

As described previously, a plurality of different types of adverts may be downloaded for use by the STB. For example, EPG adverts may comprise display panels and banners, and audio-visual adverts may be of different durations. Some adverts, according to their header information, may be eligible only for display in certain areas, at certain times of day/week, or when a viewer is tuned to certain channels. Moreover some adverts may expire during their stored lifetime on an STB if a certain threshold level of impressions is achieved, or if its cumulative display time exceeds a certain level.

In the case of an EPG, a priority stack of eligible, non-expired adverts is continuously maintained for each display area in order of increasing urgency U, according to the prioritisation methods described previously. An example of a prioritisation table 62 is shown in FIG. 11. The top R adverts 64 with the highest U are placed in a display stack 66. Each time an area in the EPG, for example AD 1 56 of FIG. 5, is displayed, the advert currently at the top of the display stack 66 associated with that area is displayed. After a certain duration, or if the viewer changes focus to another EPG screen so that the area is no longer displayed, the display stack 66 is rotated, so that advert 1 goes to the end of the stack and advert 2 is rotated to the first position in the stack. This is desirable to ensure that viewers do not become bored by seeing the same advert each time they enter the EPG and, at the same time, to ensure that a viewer sees all adverts of likely relevance.

Whilst the above description has focused on adverts that are stored for later selection and display in the EPG, advances in digital TV compression have made it feasible for a broadcaster to broadcast multiple audio-visual television adverts so that, during commercial breaks within a television program, a set top box may select for display any one of the multiple audio-visual advert clips. The targeting method described above may be applied advantageously to such systems in order to show adverts that are most relevant to a current viewer. FIG. 12 shows an audio-video program stream 68, which includes a first program m−1, a first section 70 of a second program m, a commercial break 72 that has a first 30 s advert slot, a second 15 s advert slot and a second section 74 of the second content slot. Transmitted with the content stream 68 are a plurality of adverts 76 for the 30 s slot and a plurality of adverts 78 for the 15 s slot. It will be appreciated, however, that the adverts could be transmitted at an earlier time and stored in a storage device for later retrieval. As before, associated with each advert are various demographic characteristics.

In use, the program stream 68 is either decoded and displayed by the STB 22 as it is received in real time from a broadcast service or from a storage device that is local to or within the STB 22 itself, or from a remote video-on-demand (VOD) server across a digital subscriber loop (DSL), cable or internet network. In any case, the program stream 68 includes marker packets 80 to time stamp the commencements of advert slots 72 and identify their type. These marker packets 80 are provided a certain “guard period” 82 in advance of the advert slots themselves to allow the STB 22 sufficient time to calculate and compare each advert's urgency, U.

In the case where a program is received and displayed from a broadcast in real time, the associated target viewer probability characteristics, q_{ca,m}, are broadcast to and downloaded by the STB 22 prior to its beginning. These characteristics are then used to update the appropriate time segment viewing profile, S, according to time of day and week according to formulae (1a) and (2a) periodically while the program is being viewed. In cases where the program is played from local STB storage, the program and its associated target viewer characteristics are downloaded to the STB in advance of playback.

As described previously, a process of selecting an advert for display from a plurality of adverts is employed to determine which advert is inserted into designated time slots within a moving video display. To this end, advert headers are downloaded to the STB 22, which contain target demographic parameters. In addition to this, the advert headers may contain also a logical expression of variables (e.g. viewing times and frequencies by channel and theme, postcode, hardware serial number, model) stored within the STB 22, which, when evaluated, determine whether the advert is to be downloaded by the STB 22. As before, a target audience profile for the advert is compared with the viewer profile or that of the currently viewed program. Urgency variables are calculated for each of the adverts available for the 30 s slot and likewise for the 15 s slot. In either case, the advert having the greatest match is displayed during the appropriate time slot. This is advantageous.

The foregoing disclosure describes a system and method for targeting adverts to particular classifications of individual. In addition to targeting adverts more accurately, in practice advertisers are also concerned with ensuring that an advert accumulates over its display lifetime greater than a desired minimum number of viewed impressions within a designated psycho-demographic sub-segment of the total viewing population. For example, an advertiser of golf clubs may contract with the system's operator to achieve 1 million impressions among professional 35 to 54 year old males over the period 2^{nd} to 4^{th} of April. During this period, the advert may compete with other adverts for display—each having different target sub-segments, different impression levels and different lifetimes.

A number of means may be employed to adjust the actual impression volume achieved by an advert to a desired level. This may entail adjusting the absolute magnitude or average of the target weighting coefficients, \hat{q}, used to generate \hat{p} of equation (3a) for each advert. For example, an advert requiring a million impressions would carry a higher average of the weighting coefficients compared to another targeted at the same profile over the same period but which requires only 100,000 impressions.

In practice however, the correct weightings for each advert can be difficult or impossible to determine in advance of their broadcast. Adverts with, say, the highest 5 urgencies (U) from a total inventory of, say, 20 may be selected for sequential display within the STB. However, it is difficult to obtain an accurate, straightforward mathematical relationship between an advert's urgency and the frequency with which it is displayed. The situation becomes more complex when one considers the number of degrees of freedom that might be open to advertisers. For example, an advertiser may choose to limit the display of a particular advert to certain times of the day or days of the week. Additionally, an advertiser might position an advert to be displayed in a particular mode of use of EPG. For example, a golf advert might be displayed when a viewer has entered the EPG during viewing of a sports program. Or an advert may be designated to appear on particular EPG screens. For example, an advert for a toy may appear only on an EPG search screen for childrens' programs. In each case the composition and urgency of adverts competing for display will vary from home to home—and from time to time according to the program listing schedules. The calculation as to which adverts are at the top of each display stack and the frequencies with which they are displayed, is non trivial. Furthermore, the accuracy of the viewer profiles (S) that are accumulated over time in each STB are subject to statistical errors and also to limitations inherent in the targeting algorithm.

For the aforesaid reasons, it is advantageous to conduct statistical modeling of the behaviour of the targeting processes employed within the STB population in order to predict and optimize their behaviour. The model simulates real TV viewers and their interaction with the EPG across a statistically weighted cross section of the viewing population. The model predicts the volume of impressions that would be achieved by an advert during its lifetime for a given set of system parameters and gives aggregate impression levels over time for given population sub-segments. For example, the model could be used to predict the number of impressions achieved among 20 to 35 year old single males without dependants living in London between 2 and 4^{th} April.

The simulation method involves random sampling of the set top box population and, for each viewer in the sample, simulating their behaviour in the relevant time domain. This method is widely known to those skilled in the art as “Monte Carlo simulation”. However, other forms of simulation may also be employed, including estimation of impression levels using closed mathematical formulae that are a function of system parameters. By repeating the simulation a number of times for different possible weighting values of \hat{q} for each advert, it is possible to adjust an advert's weightings to the optimum values required to meet a desired impression volume in advance of its broadcast. Moreover, the optimisation can be performed using a model that includes other adverts also scheduled to be carried by the EPG over the same period.

FIG. 13 illustrates a targeted advertising system containing a processor-based Monte Carlo optimizer 84. The system comprises a data centre 86 which, in addition to broadcasting the television audio-visual channels (not shown), broadcasts data to a “client population” of set top boxes 88 using the targeted advert display algorithms, processes and methods described previously. The data includes the television listing schedule for each program for each channel, the viewing probabilities q for each program and/or genre, the adverts' contents, their optimized weighting coefficients \hat{q} and current weighting parameters 92. In addition, the model further receives details of the desired target psycho-demographic segments for each television program and advert and impressions levels for each advert. This is typically povided from a dedicated advert server 90. The physical method for transporting these may be via cable, terrestrial or satellite broadcasting or by delivery across a point-to-point network such as the internet. Using the information available, the Monte Carlo optimizer 84 estimates the weighting parameters required to ensure a pre-determined number of impressions for selected adverts.

It is desirable to characterise empirically the client population 88 to ensure that the model is accurate. To do this it is necessary to provide a degree of information feedback from viewers to the data centre. Two types of information return paths from a sample of the client population to the data centre may be employed. The first type 92 is psycho-demographic (age, gender etc) data volunteered for each viewer via either an on-line questionnaire (resident on the set top box) or a paper one. The second type 94 is continuous, automatically gathered set top box usage data normally reported to the data centre on at least a daily basis. Where possible these include time series logs or “click streams” of viewer interactions or “events” such as remote control key presses with the set top box. The click stream also carries time stamps for each event to allow the data centre to later examine the stream to determine arbitrary usage characteristics, such as frequency of use, or time spent viewing a particular channel. Preferably the click stream data also includes periodic polling of the status of the set top box, e.g. channel tuned to, whether EPG is being displayed, what position in EPG. Status data reported back may include details of which advert was seen, when, for how long, in what EPG display, and the type of advert impression, e.g. whether just the advert panel alone was seen, or whether a viewer highlighted the advert to read more information. These data are advantageous to both calibrate and optimise the model used within the Monte Carlo optimizer 84 and also to verify to advertisers how and to what extents their adverts are seen.

Whilst the invention is described with reference to a television system, it will be appreciated that it could equally be applied to an internet based or other such system. In this case, each time a viewer enters a specific web site, viewer characteristics associated with that web site are downloaded to the viewer's terminal. The application in the viewer's terminal then functions as before to read the characteristics associated with the site and characteristics associated with a plurality of adverts. These characteristics are then compared with the advert characteristics and a specific advert is displayed when there is a sufficient match between the site and the advert characteristics. In addition, the software application is operable to monitor the characteristics of web sites that the viewer accesses in order to build up a characteristic viewer profile for comparing with the characteristics of adverts that can be displayed. As before this could be segmented by time in order to distinguish between viewers. Of course, should the viewer have access to both the internet and a television system, the characteristic profile could be built up using information from both the web sites visited and the television programs viewed.

The systems and methods described above provide a convenient way for targeting adverts to a viewer. The software that monitors a viewer's viewing pattern can be held in the viewer's equipment. This could be any one of a television, a PC, a video recorder, such as a VCR, PVR or DVD, a STB, a mobile telephone, a portable electronic book (eBook) or a PDA. This is advantageous as the viewer's privacy is not compromised by remote monitoring of their activities.

The method described herein targets individual viewer demographic segments. Moreover, it can locate an individual viewer in a multiple viewer per home environment according to his/her time of day/week viewing habits. This is advantageous. Furthermore, the method is economical with memory and can be implemented in around 20 Kbytes or less of RAM. Moreover, units in which the system is to be implemented may be re-configured dynamically over time to reflect adjustments and refinements to the demographic segmentation scheme.

A skilled person will appreciate that variations of the disclosed arrangements are possible without departing from the invention. Accordingly, the above description of a specific embodiment is made by way of example and not for the purposes of limitation. It will be clear to the skilled person that minor modifications can be made without significant changes to the operation described above.

1. A method of targeting adverts at viewers, the method comprising:
reading a plurality of target viewer characteristics relating to an image being currently viewed;
storing information associated with the target viewer characteristics in a multi-dimensional space, thereby to define a multi-dimensional viewer profile;
updating the information in the multi-dimensional viewer profile, when another image having a plurality of viewer characteristics is viewed;
comparing the multi-dimensional viewer profile with a multi-dimensional target viewer profile associated with an advert, and
displaying the advert when there is a sufficient match between the multi-dimensional viewer profile and the multi-dimensional target viewer profile.

2. A method as claimed in claim 1 further comprising weighting the target viewer characteristics relating to the image being viewed according to a pre-determined criterium and using the weighted characteristics to up-date the viewer profile.

3. A method as claimed in claim 2, wherein the weighting of particular characteristics is a function of time spent by the viewer viewing the image.

4. A method as claimed in any one of the preceding claims, wherein the step of comparing is conducted for a plurality of adverts and the step of displaying involves displaying the advert with the best match.

5. A method as claimed in any one of the preceding claims, further comprising downloading viewer characteristics relating to the currently viewed image.

6. A method as claimed in any one of the preceding claims further comprising storing a plurality of adverts in a memory, which adverts are for use in the step of comparing.

7. A method as claimed in claim 6 comprising ranking the adverts stored in memory and displaying the adverts in order of rank.

8. A method as claimed in claim 7, wherein the step of ranking invloves comparing target viewer characteristics associated with the advert and the viewer profile, wherein the degree of match determines the rank of a particular advert.

9. A method as claimed in claim 6 or clam 7 comprising up-dating the adverts stored, wherein the step of up-dating preferably comprises downloading or transmitting the up-dated adverts from a remote location to the memory.

10. A method as claimed in any one of the preceding claims further comprising dividing a pre-determined time period into time segments.

11. A method as claimed in claim 6, wherein the multi-dimensional viewer profile is determined for at least one of the time segments, preferably each time segment.

12. A method as claimed in any one of the preceding claims, wherein the viewer characteristics comprise demographic parameters, such as age, gender, status or socioeconomic class and/or psycho-graphic and/or lifestyle parameters, such as active investment, health consciousness, environmental consciousness, jet-setting, learning.

13. A method as claimed in any one of the preceding claims, wherein the step of displaying involves displyaing the advert as part of a television program listings or an electronic program guide.

14. A method as claimed in any one of the preceding claims, wherein the advert comprises a display panel or pop-up icon, which when selected provide more information on the product.

15. A method as claimed in any one of the preceding claims, wherein the advert comprises a conventional audio-visual television advertisement.

16. A method as claimed in any one of the preceding claims, further comprising inserting the advert into or between television programs.

17. A method as claimed in any one of the preceding claims, wherein the advert contains interactive content embedded within it.

18. A method as claimed in claim 16, wherein the embedded content includes a software application, which is selectable by the viewer.

19. A method as claimed in any one of the preceding claims wherein the advert contains a link or URL to additional content.

20. A method as claimed in any one of the preceding claims, wherein the image is a television program or an internet or digital site.

21. A method as claimed in any one of the preceding claims comprising modelling viewing behaviour for a plurality of viewers and using results of the modelling to determine a weighting for an advert, which weighting is used in the step of comparing, thereby to determine the match.

22. A method as claimed in claim 20, wherein the weighting is determined so as to ensure that a given advert is displayed to target viewers a pre-determined number of times and/or for a minimum cumulative duration.

23. A method as claimed in claim 20 comprising using a Monte Carlo simulation in the step of modelling.

24. A viewer terminal comprising:
means for reading a plurality of target viewer characteristics relating to an image being currently viewed;
a memory for storing information associated with the target viewer characteristics in a multi-dimensional space, thereby to define a multi-dimensional viewer profile;
means for updating the information in the multi-dimensional viewer profile, when another image having a plurality of viewer characteristics is viewed;
means for comparing the multi-dimensional viewer profile with a multi-dimensional target viewer profile associated with an advert, and
means for causing the advert to be displayed when there is a sufficient match between the multi-dimensional viewer profile and the multi-dimensional target viewer profile.

25. A viewer terminal as claimed in claim 24 further comprising means for weighting the target viewer characteristics relating to the image being viewed according to a pre-determined criterium, prior to up-dating of the viewer profile.

26. A viewer terminal as claimed in claim 25, wherein the weighting of particular characteristics is a function of time spent by the viewer viewing the image.

27. A viewer terminal as claimed in any one of claims 24 to 26, wherein the means for comparing is operable to compare a plurality of adverts and determine the advert with the best match.

28. A viewer terminal as claimed in any one of claims 24 to 27, further comprising means for receiving viewer characteristics relating to the currently viewed image from a remote location.

29. A viewer terminal as claimed in any one of claims 24 to 28, wherein a plurality of adverts are stored in the memory, which adverts are for use in the step of comparing.

30. A viewer terminal as claimed in claim 29 comprising means for ordering the adverts stored in memory.

31. A viewer terminal as claimed in claim 30, wherein the means for ordering are operable to compare the degree of match between the target viewer characteristics associated with the advert and the viewer profile, wherein the degree of match determines the position of a particular advert in the order.

32. A viewer terminal as claimed in any one of claims 24 to 31 further comprising means for dividing a pre-determined time period into time segments.

33. A viewer terminal as claimed in claim 32, wherein the multi-dimensional viewer profile is determined for at least one of the time segments, preferably each time segment.

34. A viewer terminal as claimed in any one of claims 24 to 33, wherein the viewer characteristics comprise demographic parameters, such as age, gender, status or socio-economic class and/or psycho-graphic and/or lifestyle parameters, such as active investment, health consciousness, environmental consciousness, jet-setting, learning.

35. A viewer terminal as claimed in any one of claims 24 to 34, wherein the advert is displayed as part of a television program listings or an electronic program guide.

36. A viewer terminal as claimed in any one of claims 24 to 35, wherein the advert comprises a display panel or pop-up icon, which when selected provide more information on the product.

37. A viewer terminal as claimed in any one of claims 24 to 36, wherein the advert comprises a conventional audio-visual television advertisement.

38. A viewer terminal as claimed in any one of claims 24 to 37, further comprising means for inserting the advert into or between television programs.

39. A viewer terminal as claimed in any one of claims 24 to 38, wherein the advert contains interactive content embedded within it.

40. A viewer terminal as claimed in claim 39, wherein the embedded content includes a software application, which is selectable by the viewer.

41. A viewer terminal as claimed in any one of the preceding claims wherein the advert contains a link or URL to additional content.

42. A viewer terminal as claimed in any one of claims 24 to 41, wherein the terminal is a television or a set top box or a VCR or any other television device or a PC-television or a PC.

43. A method for targeting adverts, the method comprising reading a plurality of viewer characteristics relating to an image currently being viewed; comparing the viewer characteristics relating to the image with target viewer characteristics associated with an advert, and displaying the advert when there is a sufficient match between the image viewer characteristics and the advert target viewer characteristics associated.

44. A method as claimed in claim 43, wherein the step of comparing is conducted for a plurality of adverts and the step of displaying involves displaying the advert with the best match.

45. A method as claimed in claim 43 or claim 44, further comprising downloading viewer characteristics relating to the currently viewed image.

46. A method as claimed in any one of claims 43 to 45, further comprising storing a plurality of adverts in a memory, which adverts are for use in the step of comparing.

47. A method as claimed in claim 46 comprising ranking the adverts stored in memory and displaying the adverts in order of rank.

48. A method as claimed in claim 47, wherein the step of ranking invloves comparing target viewer characteristics associated with the advert and the image, wherein the degree of match determines the rank of a particular advert.

49. A method as claimed in claim 46 or clam 47 comprising up-dating the adverts stored, wherein the step of up-dating preferably comprises downloading or transmitting the up-dated adverts from a remote location to the memory.

50. A method as claimed in any one of claims 43 to 49, wherein the target viewer characteristics relating to the image and the target viewer characteristics associated with the advert comprise demographic parameters, such as age, gender, status or socio-economic class and/or psycho-graphic and/or lifestyle parameters, such as active investment, health consciousness, environmental consciousness, jet-setting, learning.

51. A method as claimed in any one of claims 43 to 50, wherein the advert is displayed as part of a television program listings or an electronic program guide.

52. A method as claimed in any one of claims 43 to 51, wherein the advert comprises a display panel or pop-up icon, which when selected provide more information on the product.

53. A method as claimed in any one of claims 43 to 52, wherein the advert comprises an audio-visual television advertisement.

54. A method as claimed in any one of claims 43 to 53, further comprising inserting the advert into or between television programs.

55. A method as claimed in any one of claims 43 to 53, wherein the advert contains interactive content embedded within it.

56. A method as claimed in claim 55, wherein the embedded content includes a software application, which is selectable by the viewer.

57. A method as claimed in any one of claims 43 to 56, wherein the advert contains a link or URL to additional content.

58. A method as claimed in any one of claims 43 to 57, wherein the image is a television program or an internet or digital site.

59. A viewer terminal for targeting adverts, the viewer terminal comprising means for receiving a plurality of viewer characteristics relating to an image currently being viewed; means for comparing the plurality of viewer characteristics relating to the image with target viewer characteristics associated with an advert, and means for causing the display of the advert when there is a sufficient match between the image viewer characteristics and the target viewer characteristics associated with the advert.

60. A viewer terminal as claimed in claim 59, wherein the means for comparing is operable to compare the target viewer characteristics for a plurality of adverts and cause the displaying of the advert with the best match.

61. A viewer terminal as claimed in claim 59 or claim 60, further comprising means for receiving from a remote location viewer characteristics relating to the currently viewed image.

62. A viewer terminal as claimed in any one of claims 59 to 60, further comprising a memory for storing a plurality of adverts, which adverts are for use in the step of comparing.

63. A viewer terminal as claimed in claim 62 comprising means for ranking the adverts stored in memory and displaying the adverts in order of rank.

64. A viewer terminal as claimed in claim 63, wherein the means for ranking comprise means for determining the degree of match between the image and the advert characteristics.

65. A viewer terminal as claimed in any one of claims 59 to 64, wherein the target viewer characteristics relating to the image and the target viewer characteristics associated with the advert comprise demographic parameters, such as age, gender, status or socio-economic class and/or psycho-graphic and/or lifestyle parameters, such as active investment, health consciousness, environmental consciousness, jet-setting, learning.

66. A viewer terminal as claimed in any one of claims 59 to 65, comprising means for displaying the advert as part of a television program listings or an electronic program guide.

67. A viewer terminal as claimed in any one of claims 59 to 66, wherein the advert comprises a display panel or pop-up icon, which when selected provide more information on the product.

68. A viewer terminal as claimed in any one of claims 59 to 67, wherein the advert comprises an audio-visual television advertisement.

69. A viewer terminal as claimed in any one of claims 59 to 68, further comprising means for inserting the advert into or between television programs.

70. A viewer terminal as claimed in any one of claims 59 to 69, wherein the advert contains interactive content embedded within it.

71. A viewer terminal as claimed in claim 70, wherein the embedded content includes a software application, which is selectable by the viewer.

72. A viewer terminal as claimed in any one of claims 59 to 71, wherein the terminal is a television or a set top box or a VCR or any other television device or a PC-television or a PC.

73. A method for delivering adverts to a plurality of viewer terminals comprising simulating viewing habits at at least a portion of the viewer terminals, the viewer terminals being operable to use viewer characteristics relating to an advert to determine whether the advert should be displayed to a viewer, using results of the step of simulating to determine a weighting factor associated with the advert viewer characteristics, and transmitting the weighting factor to the viewer terminals for use in determining whether an advert should be shown.

74. A method as claimed in claim 73, wherein the step of simulating uses a Monte Carlo simulation.

75. A method as claimed in claim 73 or claim 74, wherein the weighting factor is such as to ensure that a given advert is displayed to target viewers a pre-determined number of times and/or for a minimum cumulative duration.

76. A system for delivering adverts to a plurality of viewer terminals comprising means for simulating viewing habits at at least a portion of the viewer terminals, the viewer terminals being operable to use viewer characteristics relating to an advert to determine whether the advert should be displayed to a viewer, means for using results of the step of simulating to determine a weighting factor associated with the advert viewer characteristics, and means for transmitting or downloading the weighting factor to the viewer terminals for use in determining whether an advert should be shown.

77. A system as claimed in claim 76, wherein the step of simulating uses a Monte Carlo simulation.

78. A system as claimed in claim 76 or claim 77, wherein the weighting factor is such as to ensure that the advert is displayed at a pre-determined number of viewer terminals.
